(19) United States
(12) Patent Application Publication
(10) Pub. No.: US 2013/0002709 A1
(43) Pub. Date: Jan. 3, 2013

(54) DISPLAY CONTROL APPARATUS, DISPLAY CONTROL PROGRAM PRODUCT, AND DISPLAY CONTROL SYSTEM

(75) Inventor: Naoki Yamagata, Shiki-shi (JP)

(73) Assignee: NIKON CORPORATION, Tokyo (JP)

(21) Appl. No.: 13/583,793

(22) PCT Filed: Mar. 8, 2011
(86) PCT No.: PCT/JP2011/055391

§ 371 Date: Sep. 10, 2012

(30) Foreign Application Priority Data
Mar. 10, 2010 (JP) 2010-053021

(51) Int. Cl. G09G 5/00

(52) U.S. Cl. 345/619

(57) ABSTRACT

A display control apparatus includes a judgment unit configured to judge a type of the multi-image file which contains a plurality of sets of image data and has a predetermined common extension, by reading out type information from the multi-image file, a selecting unit configured to select, from among a plurality of display operations, a display operation that corresponds to the type judged by the judgment unit; and an executing unit configured to execute, for the multi-image file, the display operation selected by the selecting unit, and to display an image on a display apparatus.

### TECHNICAL FIELD

The present invention relates to a display control apparatus, a display control program product, and a display control system.

### BACKGROUND ART

An image recording apparatus is known as follows. Before an image in the form of an image file generated by an old-type camera is displayed, if low-resolution image data for image display is not recorded in the image file, the image recording apparatus is configured to generate such image data for image display, and to append the image data for image display thus generated to the image file (e.g., Patent document 1).

### CITATION LIST

### Patent Literature

[patent document 1] Japanese Patent Laid Open Publication No. 2009-267946

### SUMMARY OF INVENTION

### Technical Problem

However, conventional image recording apparatuses are designed without giving consideration to a function of displaying such a display image in a suitable manner according to the image file type.

### Solution to Problem

According to the first aspect of the present invention, a display control apparatus comprises: a judgment unit configured to judge a type of a multi-image file that contains a plurality of sets of image data and has a predetermined common extension, by reading out type information from the multi-image file; a selecting unit configured to select, from among a plurality of display operations, a display operation that corresponds to the type judged by the judgment unit; and an executing unit configured to execute, for the multi-image file, the display operation selected by the selecting unit, and to display an image on a display apparatus.

According to the second aspect of the present invention, in the display apparatus of the first aspect, it is preferred that when there is a plurality of possible display operations that correspond to the type, the selecting unit is configured to present the plurality of display operations to the user, and to select a single display operation according to an instruction from the user.

According to the third aspect of the present invention, in the display apparatus of the second aspect, it is preferred that in the presentation of the plurality of display operations, the selecting unit is configured to present only display operations selected beforehand by the user.

According to the fourth aspect of the present invention, in the display apparatus of any one of the first through the third aspects, it is preferred that the selecting unit is configured to select the display operation also giving consideration to image acquisition information with respect to the multi-image file.

According to the fifth aspect of the present invention, in the display apparatus of any one of the first through the fourth aspects, it is preferred that the display operations include at least one from among: (1) a continuous playback operation in which image data to be displayed is switched among the plurality of sets of image data contained in the multi-image file, and a set of image data thus switched is displayed; (2) a combining playback operation in which the plurality of sets of image data contained in the multi-image file are combined, and a set of image data thus combined is displayed; and (3) a playback-with-guide operation in which, in a case in which the plurality of sets of image data contained in the multi-image file are laid out so as to generate a single laid-out image, a given single image is displayed from among the plurality of sets of image data contained in the multi-image file while information is displayed which indicates a laid-out position of the currently-displayed image in the laid-out image.

According to the sixth aspect of the present invention, a computer program product comprises a display control program configured to instruct a computer to execute: a judgment step of judging a type of a multi-image file which contains a plurality of sets of image data and has a predetermined common extension, by reading out type information from the multi-image file; a selecting step of selecting, from among a plurality of display operations, a display operation that corresponds to the type judged in the judgment step; and an execution step of executing, for the multi-image file, the display operation selected in the selecting step, and of displaying an image on a display apparatus.

According to the seventh aspect of the present invention, a display control system comprises a display control apparatus; and a display apparatus, wherein: the display control apparatus comprises: a judgment unit configured to judge a type of a multi-image file which contains a plurality of image data and has a predetermined common extension, by reading out type information from the multi-image file; a selecting unit configured to select, from among a plurality of display operations, a display operation that corresponds to the type judged by the judgment unit; and an executing unit configured to execute, for the multi-image files, the display operation selected by the selecting unit, and to display an image on a display apparatus and wherein the display apparatus comprises a display unit configured to display an image according to the display control signal received from the display control apparatus.

According to the eighth aspect of the present invention, a display control method executed by a computer comprises a judgment step of judging a type of a multi-image file which contains a plurality of sets of image data and has a predetermined common extension, by reading out type information from the multi-image file; a selecting step of selecting, from among a plurality of display operations, a display operation that corresponds to the type judged in the judgment step; and an execution step of executing, for the multi-image file, the display operation selected in the selecting step, and of displaying an image on a display apparatus.

### Advantageous Effect of the Invention

With the present invention, such an arrangement is capable of providing a suitable manner of display according to the image file type.

### BRIEF DESCRIPTION OF THE DRAWINGS

FIG. 1 is a block diagram which shows a configuration of a camera according to an embodiment.

FIG. 2 is a schematic diagram which shows a data structure of an MPF file.

FIG. 3 is a diagram which shows a specific example of a continuous playback operation.

FIG. 4 is a first diagram which shows a specific example of a “playback with multiple exposure effect” operation.

FIG. 5 is a second diagram which shows a specific example of a “playback with multiple exposure effect” operation.

FIG. 6 is a diagram which shows a specific example of a “playback with panorama guide” operation.

FIG. 7 is a diagram which shows a specific example of a “playback with multi-angle guide” operation.

FIG. 8 is a diagram which shows a specific example of an MPF file playback method setting menu.

FIG. 9 is a diagram which shows a specific example of a playback method combination table.

FIG. 10 is a flowchart which shows the flow of image playback processing.

FIG. 11 is a diagram which shows a specific example of a displayed guide which indicates that a current image can be subjected to a “playback with effects” operation.

FIG. 12 is a flowchart which shows the flow of the steps executed in a “continuous playback” operation.

FIG. 13 is a flowchart which shows the flow of the steps executed in a “playback with multiple exposure effect” operation.

FIG. 14 is a flowchart which shows the flow of the steps executed in a “playback with panorama guide” operation.

FIG. 15 is a flowchart which shows the flow of the steps executed in a “playback with multi-angle guide” operation.

FIG. 16 is a diagram for describing an operation in which a program is supplied.

### DESCRIPTION OF EMBODIMENTS

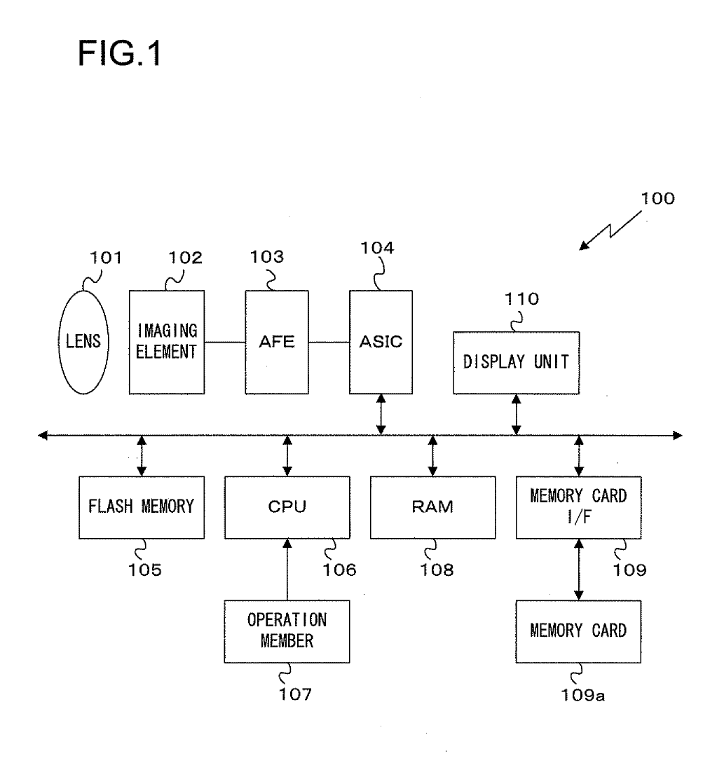

FIG. 1 is a block diagram which shows a configuration of a camera according to the present embodiment. A camera 100 comprises a lens 101, an imaging element 102, an AFE (Analog Front End) 103, an ASIC 104, a flash memory 105, a CPU 106, an operation member 107, RAM 108, a memory card I/F 109, and a display unit 110.

The lens 101 is formed of multiple optical lenses. However, FIG. 1 shows the lens 101 as a single lens which represents such multiple lenses. The imaging element 102 is configured as an image sensor such as a CCD image sensor, a CMOS image sensor, or the like, and is configured to acquire an image signal of a subject image formed by the lens 101. Subsequently, the image signal obtained by image acquisition is output to the AFE 103. The AFE 103 is configured to perform various kinds of processing on the analog signal input from the imaging element 102, to convert the analog signal into a digital signal, and to output the digital signal to the ASIC 104. The ASIC 104 is configured to perform various kinds of image processing on the digital signal thus input. Examples of such image processing include interpolation processing, image tone processing, edge enhancement processing, white balance adjustment processing, image compression processing, image decompression processing, etc.

The flash memory 105 is configured as nonvolatile memory, and is configured to store program data to be executed by the CPU 106, various kinds of parameters to be read out when the program is executed, and so forth. The CPU 106 is configured to control the overall operation of the camera 100. The operation member 107 includes various kinds of input members which allow the user to perform an input operation, such as a power switch button, a release button, a zoom button, a cross key, an OK button, a playback button, a delete button, etc., for example. The operation member 107 is configured to output, to the CPU 106, the operation signals input via such various kinds of input members. The CPU 106 is configured to control the camera 100 according to these input operation signals.

The RAM 108 is configured as volatile memory, and is employed as work memory in which a program is stored when the program is to be executed by the CPU, or otherwise is employed as buffer memory for temporarily storing data. The memory card I/F 109 includes a memory card slot which allows a memory card 109a such as an SD card to be inserted. Such an arrangement allows data to be read out from and to be written to the memory card 109a inserted into the memory card slot.

The display unit 110 is configured as a liquid crystal monitor (back-side monitor) mounted on the back face of the camera 100, for example. The display unit 110 is configured to display an image stored in the memory card 109a, or a setting menu which allows the user to configure the settings of the camera 100. Furthermore, when the user sets the mode of the camera 100 to an image acquisition mode, the CPU 106 supplies the image signals sequentially input from the imaging element 102 i to the display unit 110. Thus, the display unit 110 displays a live view image.

With the present embodiment, the CPU 106 generates a main image data with predetermined image format, such as JPEG format for example, based upon the image data subjected to the image processing by the ASIC 104 (JPEG data). Furthermore, the CPU 106 is configured to generate image data for image display, such as thumbnail image data having an image size of 180 by 120 pixels and thumbnail image data for viewing having an image size of 600 by 400 pixels, for example. The CPU 106 is configured to generate an image file, e.g. a JPEG file, obtained by adding header information to an image file containing the main image data, the thumbnail image data, and the thumbnail image data for viewing, and to output the image file thus generated to the memory card I/F 109.

Also, with the present embodiment, the CPU 106 is capable of generating an image file storing multiple JPEG data, in addition to a function of generating the aforementioned JPEG file, i.e., an image file storing a single JPEG data set. For example, when image acquisition is performed in a continuous shooting mode, a panorama mode, or an interval shooting mode, multiple JPEG data are generated as a single set for each image acquisition. In this case, such multiple JPEG data thus generated can be recorded in a single image file.

Furthermore, the CPU 106 may be configured to generate image data for monitor display from the main image data having an image size that differs from that of the aforementioned thumbnail image data or the thumbnail image data for viewing, and to record the image data for monitor display together with the main image data, thereby recording multiple image data in a single image file. For example, the CPU 106 may be configured to generate VGA size (640 by 480 pixels) image data for monitor display or full HD size (1920 by 1080 pixels) image data for monitor display, and to store such image data thus generated in a single image file.

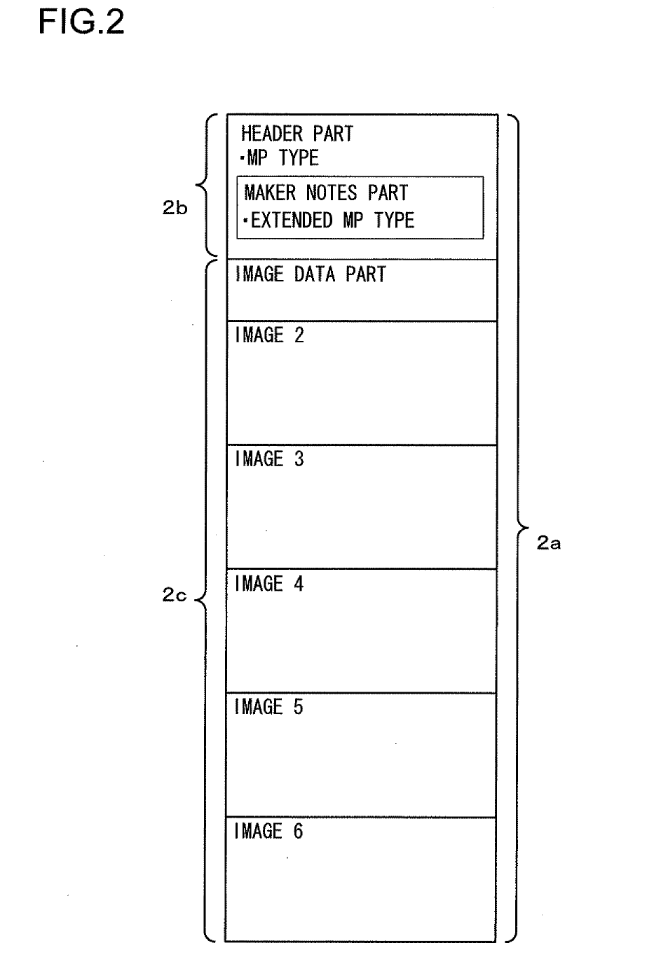

With the present embodiment, a JPEG file (with an extension “.jpg”) has a file structure in which single main image data is stored in a single image file. Similarly, an image file, which will be referred to as an “MPF file (Multi Picture Format file,with an extension “.mpo”, i.e. multi-image file), has a file structure in which multiple main image data are stored in a single image file. Such an MPF file has a file structure in which a single image file 2a includes a header part 2b and an image data part 2c as shown in FIG. 2 for example. The image data part 2c stores multiple image data. Of these multiple image data, the image data recorded in the leading part will be referred to as the “first individual image”.

Furthermore, the header part 2b stores information with respect to the MP type for MPF file identification. As such MP types, the following types are defined in the standard.

(A) Baseline MP, primary image.

(B) Image for monitor display, class 1, VGA equivalent.

(C) Image for monitor display, class 2, Full HD equivalent.

(D) Multi-view individual image, panorama mode.

(E) Multi-view individual image, disparity mode.

(F) Multi-view individual image, multi-angle mode.

(G) Undefined type.

Of the aforementioned MP types, the “undefined type” is set for a case in which the image data to be recorded in the MPF file does not belong to any one of the types (A) through (F). In a case in which the “undefined type” is recorded as the MP type, such an arrangement allows an extended MP type to be recorded in a maker notes part. For example, in a case in which multiple images acquired in a continuous shooting mode are recorded in an MPF file, the extended MP type information “continuous shooting” can be recorded in this MPF file. In a case in which multiple images acquired in a fixed-point image acquisition mode are recorded in an MPF file, the extended MP type information “fixed-point image acquisition” can be recorded in the MPF file. It should be noted that a predetermined common extension “.mpo” is assigned to each MPF file, regardless of the MP type described above.

With the camera 100 according to the present embodiment, upon receiving an instruction to play back an image, the CPU 106 is configured to read out the MP type and the extended MP type for each MPF file recorded in the memory card 109a so as to identify the MPF file type, and to play back the image with the playback effect that corresponds to the MPF file type. In this stage, depending on the MPF file type, the CPU 106 determines the playback method giving consideration to the image acquisition conditions recorded in the header part 2b of the MPF file. For example, the CPU 106 selects an image playback method from among “regular playback”, “continuous playback”, “playback with multiple exposure effect”, “playback with panorama guide”, and “playback with multi-angle guide”.

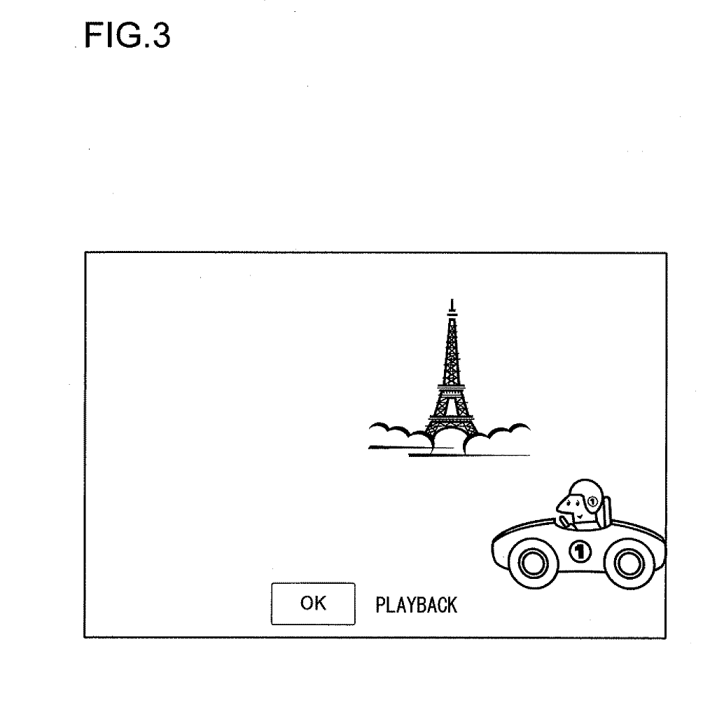

Here, description will be made regarding each playback method. The “regular playback” method represents a playback method in which a single image is displayed on the display unit 110 in the full-screen mode. The “continuous playback” method represents a playback method in which multiple image data stored in an MPF file are consecutively displayed at predetermined time intervals in a frame-by-frame manner, as shown in FIG. 3.

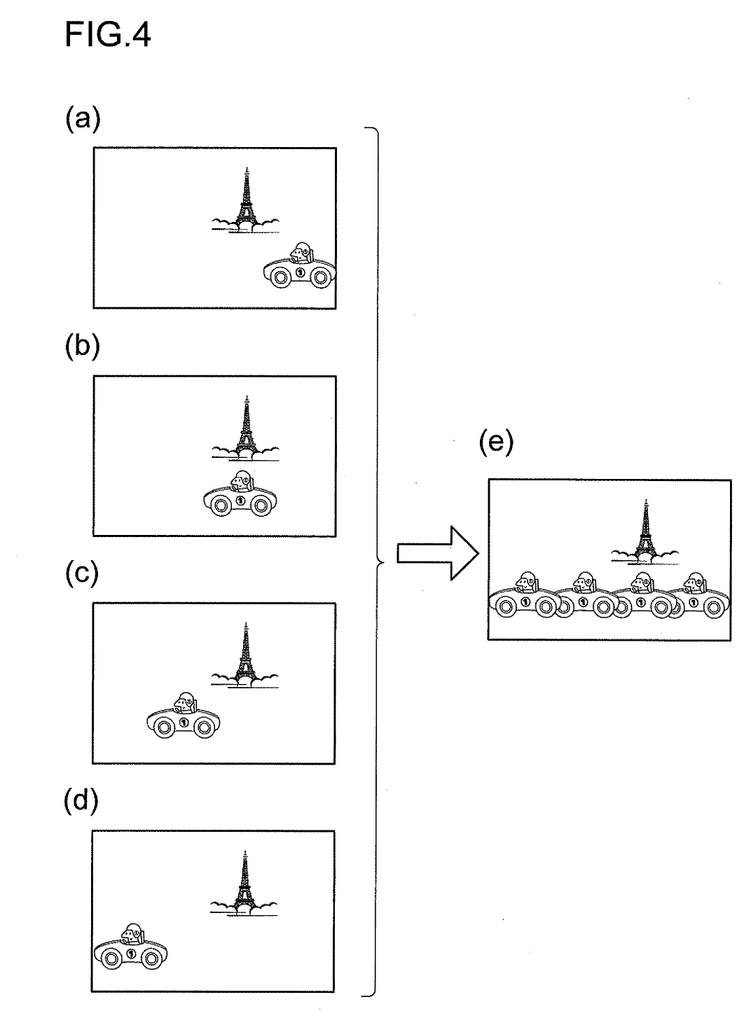

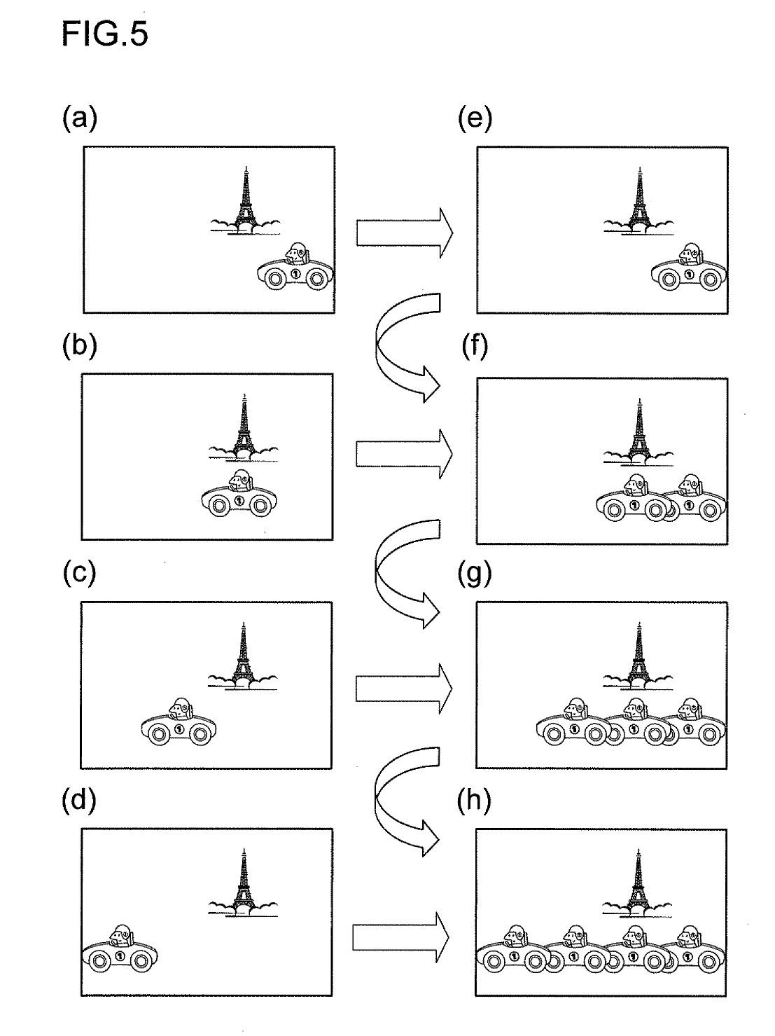

The “playback with multiple exposure effect” method represents a playback method in which, when multiple image data as shown in FIGS. 4A through 4D are stored in an MPF file, such multiple image data are superimposed so as to generate a single image as shown in FIG. 4E. Otherwise, with the “playback with multiple exposure effect” method, when multiple image data as shown in FIGS. 5A through 5D are stored in the MPF file, first, as shown in FIG. 5E, only a first image shown in FIG. 5A may be displayed. After a predetermined period of time elapses, the image which is currently displayed as shown in FIG. 5E and the second image shown in FIG. 5B may be superimposed, thereby displaying an image shown in FIG. 5F. After a predetermined period of time again elapses, the image which is currently displayed as shown in FIG. 5F and the third image shown in FIG. 5C may be superimposed, thereby displaying an image shown in FIG. 5G. After a predetermined period of time yet again elapses, the image which is currently displayed as shown in FIG. 5G and the fourth image shown in FIG. 5D may be superimposed, thereby displaying an image shown in FIG. 5H.

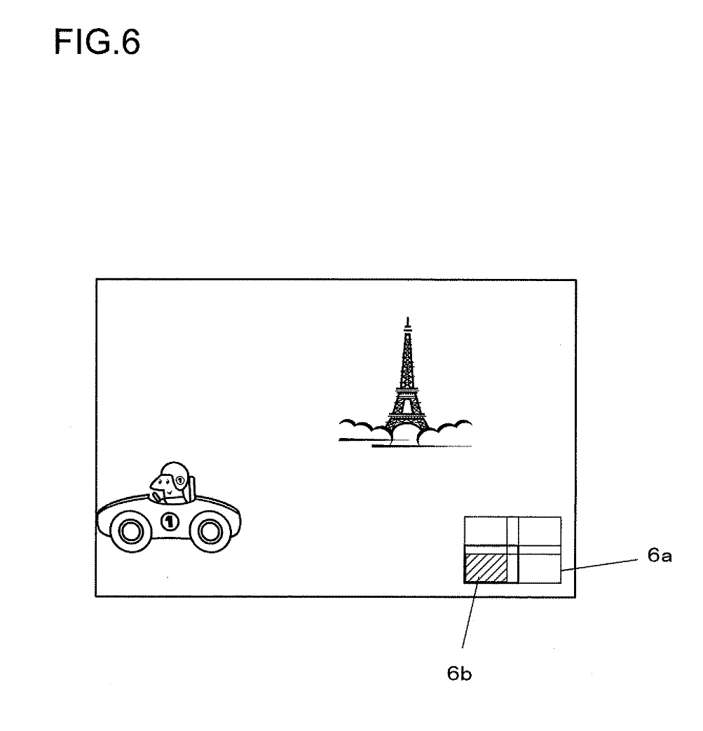

The “playback with panorama guide” method represents a playback method in which, as shown in FIG. 6, a single image is displayed from among multiple image data stored in an MPF file, and a panorama guide frame 6a is superimposed on the image such that the position of the image which is currently displayed is indicated in a panorama image formed of multiple image data stored in the MPF file. With such a method, the frame 6b that corresponds to the position of the image that is currently displayed may be displayed in a special display manner that differs from the display manner of the other individual images (e.g., a hatched frame, a colored frame, etc.), thereby marking, in the panorama image, the position of the image that is currently displayed.

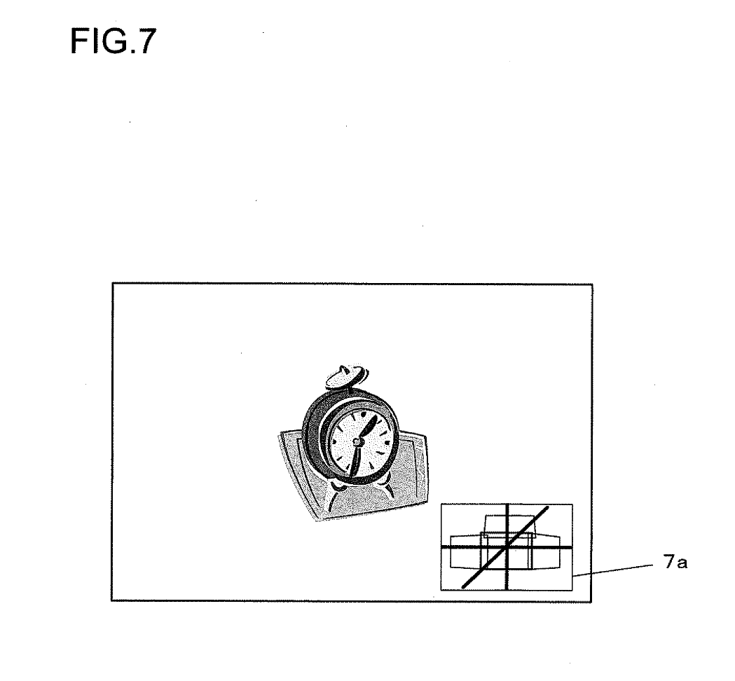

The “playback with multi-angle guide” method represents a playback method in which, as shown in FIG. 7, a single image is displayed from among multiple image data stored in an MPF file, and a multi-angle guide frame 7a is superimposed on the currently displayed image so as to indicate, with respect to the multi-angle image formed of the multiple image data stored in the MPF file, the direction of view for the image that is currently displayed. Such an arrangement displays information with respect to the direction of view for the image that is currently displayed, e.g., an eye-shaped icon which indicates the position of the viewpoint, an arrow which indicates the direction of view, or the like.

With the present embodiment, the playback methods other than the “regular playback” method, i.e., “continuous playback”, “playback with multiple exposure effect”, “playback with panorama guide”, and “playback with multi-angle guide” will be referred to as the “playback with effects” method, which are distinguished from the “regular playback” method. The effect applied to the playback operation by means of the “playback with effects” method will be referred to as the “playback effects”.

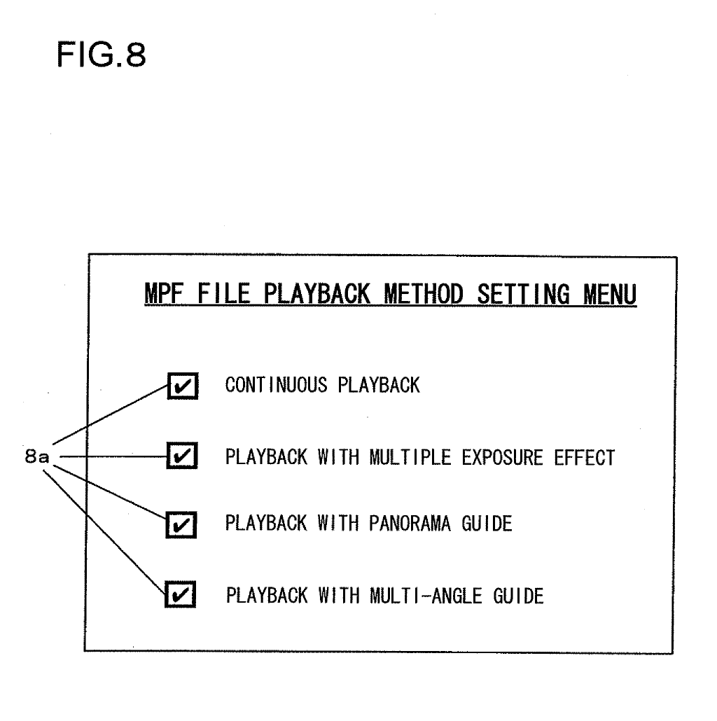

With the “playback with effects” method according to the present embodiment, such an arrangement allows the user to enable and disable the playback with effects mode beforehand. For example, by operating the operation member 107, such an arrangement allows the user to instruct the display unit 110 to display an MPF file playback method setting menu shown in FIG. 8. Next, by checking checkboxes 8a displayed for the respective playback methods, such an arrangement allows the user to enable the respective playback methods. Conversely, by unchecking the checkbox for each respective playback method, such an arrangement allows the user to disable the corresponding playback method.

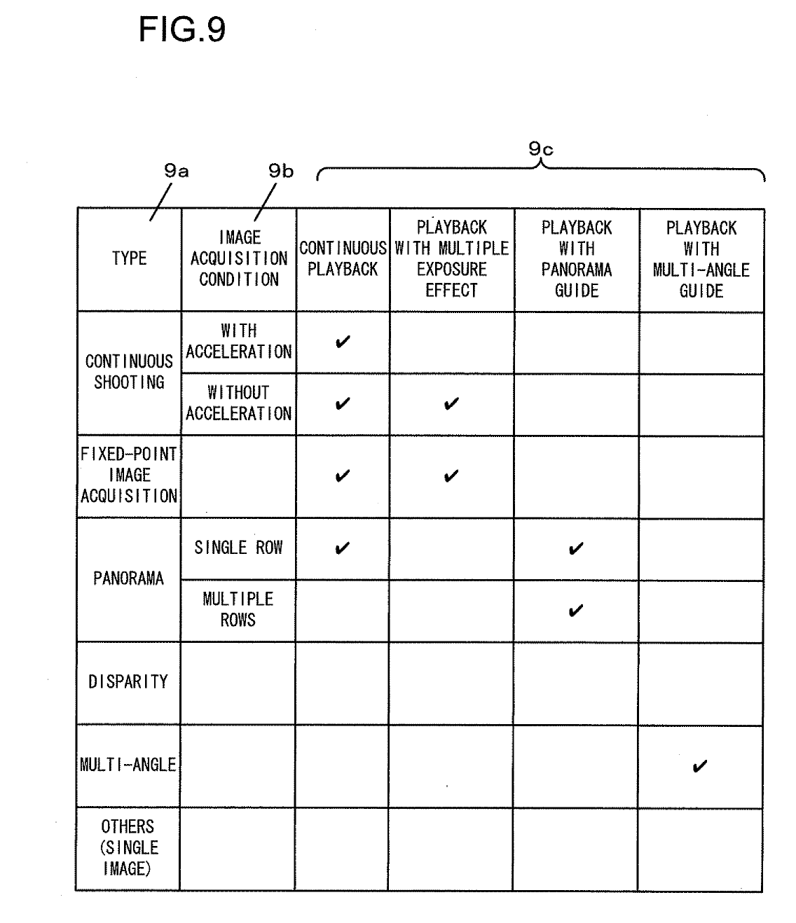

The CPU 106 determines the image playback method that corresponds to the MP type and the extended MP type (which will be collectively referred to as the “type” hereafter) and the image acquisition conditions, based upon the content of settings set via the MPF file playback method setting menu shown in FIG. 8. FIG. 9 is a diagram which shows a specific example of a playback method combination table which represents an example of the playback method determined according to the MPF file type and the image acquisition conditions. As shown in FIG. 9, the CPU 106 determines at least one or more selectable playback method candidates from among the aforementioned playback methods with effects 9c based upon the type 9a and the image acquisition conditions 9b. Subsequently, the CPU 106 selects, as the playback method for the current MPF file, the playback method enabled via the MPF file playback method setting menu shown in FIG. 8.

In this stage, when the CPU 106 cannot select the playback method candidates based upon the type 9a and the image acquisition conditions 9b, e.g., in a case in which a type that is not shown in FIG. 9 is recorded as the extended MP type, or in a case in which the candidates selected based upon the type 9a and the image acquisition conditions 9b are all disabled, the playback method for this MPF file is determined to be the “regular playback” method. Description will be made below regarding a method for selecting the playback method candidates based upon the type 9a and the image acquisition conditions 9b with reference to the playback combination table shown in FIG. 9. It should be noted that, in FIG. 9, the checked playback method matches the corresponding type 9a and the corresponding image acquisition condition 9b.

When the type 9a is “continuous shooting” and the image acquisition condition is “with acceleration”, the CPU 106 selects the “continuous playback” as the playback method candidate. It should be noted that, when an unshown acceleration sensor detects acceleration of the camera 100 in the image acquisition operation, the acceleration thus detected is recorded in the header part 2b as the image condition “acceleration”. That is to say, in a case in which the type 9a is “continuous shooting” and the image condition 9b is “with acceleration”, this means that the user acquired images by continuous shooting while panning the camera 100, thus changing the image acquisition angle. On the other hand, in a case in which the type 9a is “continuous shooting” and the image acquisition condition 9b is “without acceleration”, the CPU 106 selects “continuous playback” and “playback with multiple exposure effect” as the playback method candidates.

When the type 9a is “panorama” and the image acquisition condition 9b is “single row”, the CPU 106 selects “continuous playback” and “playback with panorama guide” as the playback method candidates. When the type 9a is “panorama” and the image acquisition condition 9b is “multiple rows”, the CPU 106 selects the “playback with panorama guide” as the playback method candidate. It should be noted that the image acquisition condition “single row” in panorama image acquisition means that a single panorama image is generated by combining multiple images in a single row along the horizontal direction or otherwise along the vertical direction. On the other hand, the image acquisition condition “multiple rows” in panorama image acquisition means that a single panorama image is generated by combining multiple images in the form of a 2 by 2 matrix or more.

When the type 9a is “disparity”, there is no matching playback method in the playback method combination table shown in FIG. 9. Accordingly, the CPU determines the playback method to be “regular playback”. When the type 9a is “multi-angle”, the CPU 106 selects the “playback with multi-angle guide” as the playback method candidate.

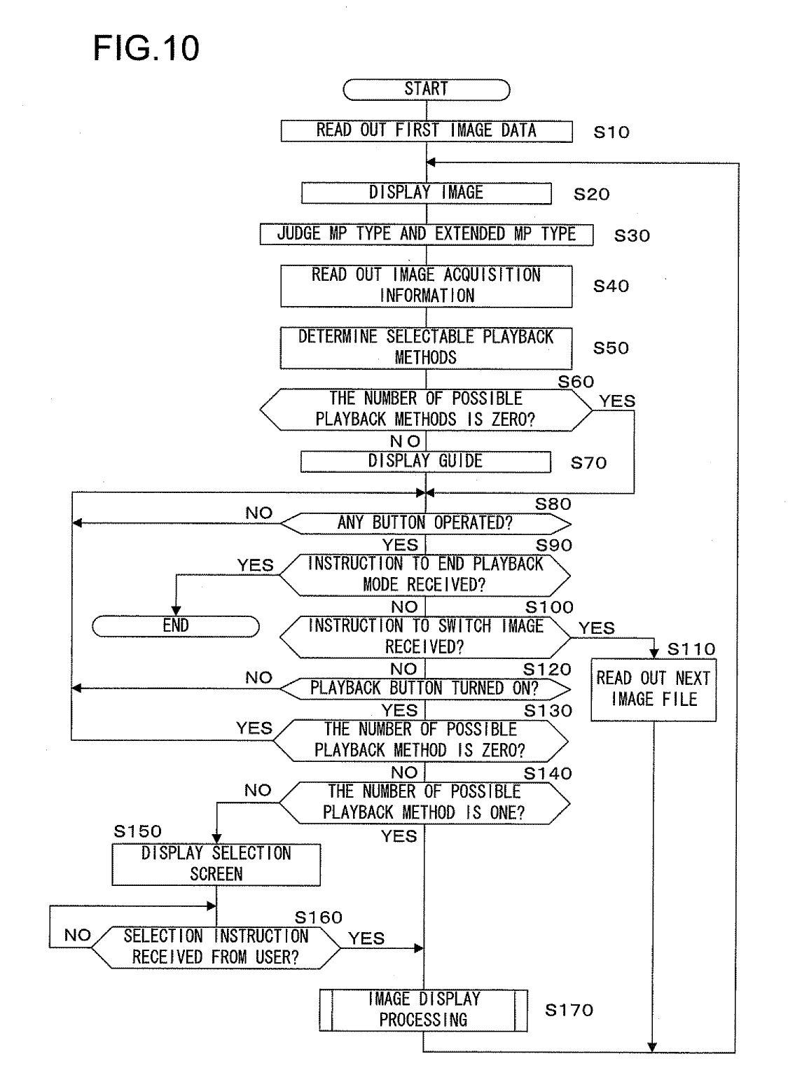

FIG. 10 is a flowchart which shows the flow of the image playback operation according to the present embodiment. The operation shown in FIG. 10 is executed by the CPU 106 as a program which is started up upon receiving an instruction to play back an image given by the user pressing the playback button included in the operation member 107. It should be noted that description will be made in the present embodiment assuming that the CPU 106 is configured to perform processing on MPF files stored in the memory card 109a. Upon receiving an image playback instruction from the user, the CPU 106 reads out and plays back the MPF files stored in the memory card 109a in file name order (e.g., in ascending order). Furthermore, the CPU 106 switches the image to the previous image or otherwise to the next image, and displays the image thus switched, according to an image switching instruction from the user.

In Step S10, the CPU 106 reads out a given MPF file as a playback target from the memory card 109a, and reads out the first image data recorded in the MPF file, i.e., reads out the first individual image data. Subsequently, the flow proceeds to S20 in which the CPU 106 displays the image data thus read out in Step S10 on the display unit 110, thereby displaying the image on a screen. Subsequently, the flow proceeds to Step S30.

In Step S30, the CPU 106 reads out the MP type and the extended MP type from the header part of the MPF file read out as the playback target, and judges the MPF file type based upon the information thus read out, and the flow proceeds to Step 40. In Step S40, the CPU 106 reads out the image acquisition information from the header part of the MPF file of the playback target, and the flow proceeds to Step S50. In Step S50, the CPU 106 determines selectable playback methods that match the MPF file type and the image acquisition information based upon the playback method combination table shown in FIG. 9 and the playback methods enabled via the MPF file playback method setting menu shown in FIG. 8. Subsequently, the flow proceeds to Step S60.

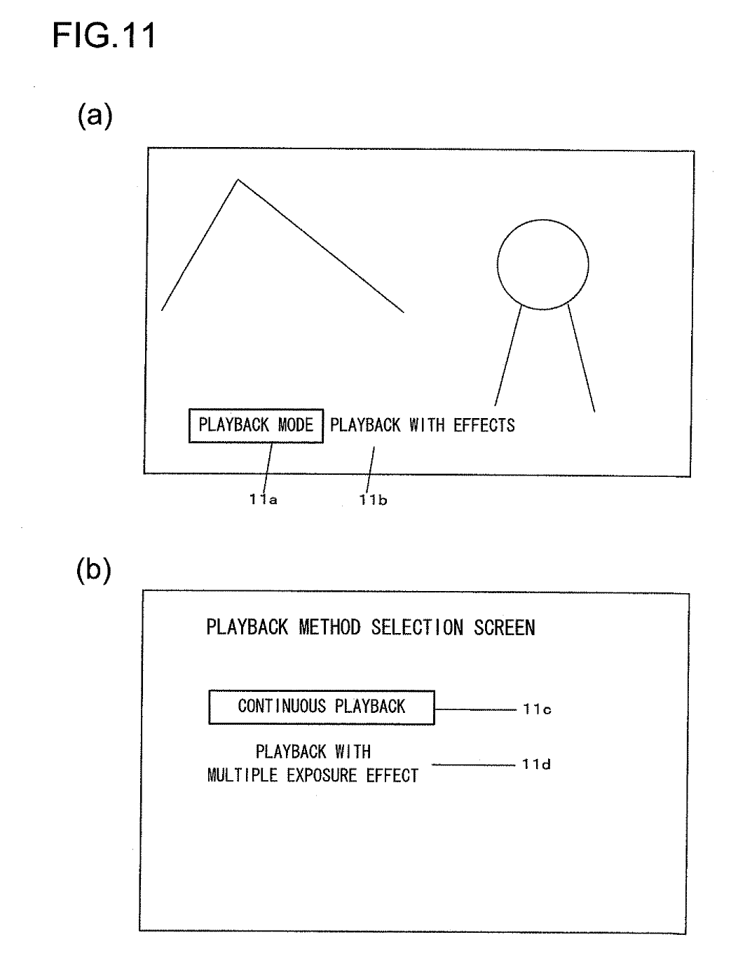

In Step S60, the CPU 106 judges whether or not the number of selectable playback methods determined in Step S50 is zero. When the judgment is “true” in Step S60, the flow proceeds to Step S80 described later. Conversely, when the judgment is “false” in Step S60, the flow proceeds to Step S70. In Step S70, the CPU 106 displays a guide which indicates that this image can be played back with effects superimposed on the image displayed on the display unit 110 as shown in FIG. 11A. It should be noted that the guide includes a “playback mode” button 11a which can be pressed by the user, and a character string 11b which indicates that playback with effects can be performed. Description will be made later regarding the operation performed when the “playback mode” button 11a is pressed.

Subsequently, the flow proceeds to Step S80 in which the CPU 106 judges whether or not the user has operated any of the respective buttons included in the operation member 107. When the judgment is “true” in Step S80, the flow proceeds to Step S90. In Step S90, the CPU 106 judges whether or not the button operation by the user matches the button operation which is an instruction to end the playback mode. When the judgment is “true” in Step S90, the operation ends. Conversely, when the judgment is “false” in Step S90, the flow proceeds to Step S100.

In Step S100, the CPU 106 judges whether or not the button operation by the user matches the image switching operation for switching the individual image which is currently displayed on the display unit 110. When the judgment is “true” in S100, the flow proceeds to Step S110. In Step S110, the CPU 106 reads out the next image file, which is the image file that follows the current playback target, from the memory card 109a, and the flow returns to Step S20. Conversely, when the judgment is “false” in Step S100, the flow proceeds to Step S120.

In Step S120, the CPU 106 judges whether or not the button operation by the user matches the operation in which the user presses the playback mode button shown in FIG. 11A. When the judgment is “false” in Step S120, the flow returns to Step S80. Conversely, when the judgment is “true” in Step S120, the flow proceeds to Step S130. In Step S130, the CPU 106 judges whether or not the number of selectable playback methods determined in Step S50 is zero. When the judgment is “true” in S130, the flow returns to Step S80. Conversely, when the judgment is “false” in Step S130, the flow proceeds to Step S140.

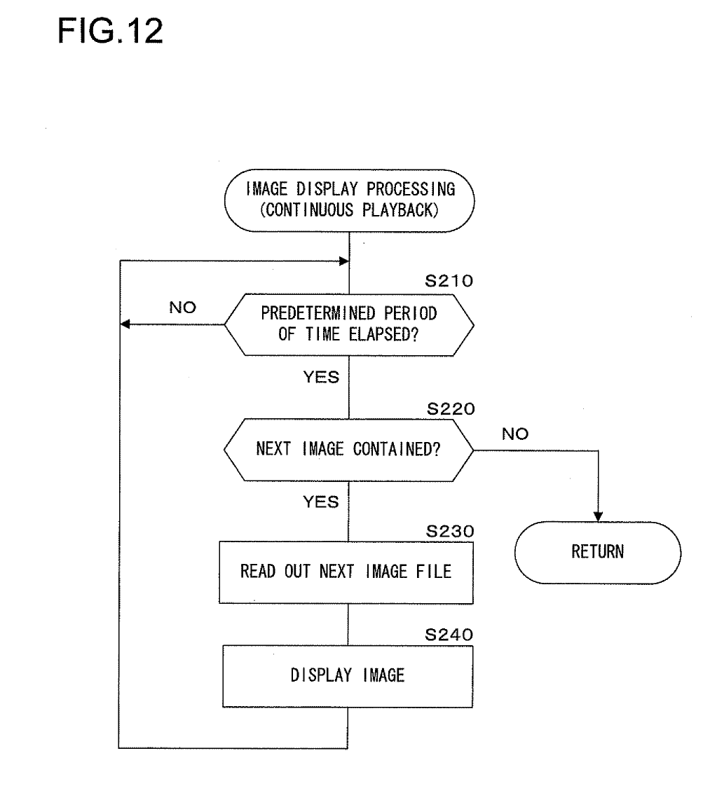

In Step S140, the CPU 106 judges whether or not the number of selectable playback methods determined in Step S50 is one. When the judgment is “true” in Step S50, the flow proceeds to Step S170. In this case, the CPU 106 can determine the image playback method to be the single image playback method candidate. Accordingly, after the CPU 106 executes image display processing for displaying the image using the playback method thus determined, the flow returns to Step S20. It should be noted that the display operations for the respective playback methods are described later with reference to FIGS. 12 through 15. Conversely, when the judgment is “false” in Step S140, the CPU 106 cannot determine the image playback method to be a particular single candidate, and accordingly, the flow proceeds to Step S150.

In Step S150, the CPU 106 displays a selection screen shown in FIG. 11B on the display unit 110. The CPU 106 displays, on the selection screen, a list of the selectable playback methods determined in Step S50, which allows the user to select one of the methods from the list. FIG. 11B shows an example of a list displaying “continuous playback” 11c and “playback with multiple exposure effect” 11d as the selectable playback method candidates. By operating the cross key included in the operation member 107 so as to align a cursor with the playback method which the user desires to select, and by then pressing the OK button, such an arrangement allows the user to select and determine the playback method.

Subsequently, the flow proceeds to Step S160 in which the CPU 106 judges whether or not the user gives an instruction, i.e., judges whether or not the user selects one playback method via the selection screen. When the judgment is “true” in Step S160, the flow proceeds to Step S170. In Step S170, the CPU 106 executes image processing for displaying the image using the playback method selected by the user. Subsequently, the flow returns Step S20.

Next, description will be made with reference to FIGS. 12 through 15 regarding the image display processing for the respective playback methods executed in Step S170. FIG. 12 is a flowchart which shows the flow of the processing executed in the “continuous playback” operation. In Step S210, the CPU 106 judges whether or not a predetermined period of time has elapsed after the playback mode button 11a is pressed in Step S120 described above with reference to FIG. 10. When the judgment is “true”, in Step S210, the flow proceeds to Step S220.

In Step S220, the CPU 106 judges whether or not, in the MPF file selected as the playback target, there is a next image which follows the image that is currently displayed. When the judgment is “false” in Step S220, the flow returns to the operation shown in FIG. 10. Conversely, when the judgment is “true” in Step S220, the flow proceeds to Step S230. In Step S230, the CPU 106 reads out, from the MPF file, the image data of the image that follows the playback target, and the flow proceeds to Step S240. In Step S240, the CPU 106 outputs the image data read out in Step S230 to the image display unit 110, thereby displaying the image data on the image display unit 110. Subsequently, the flow returns to Step S210.

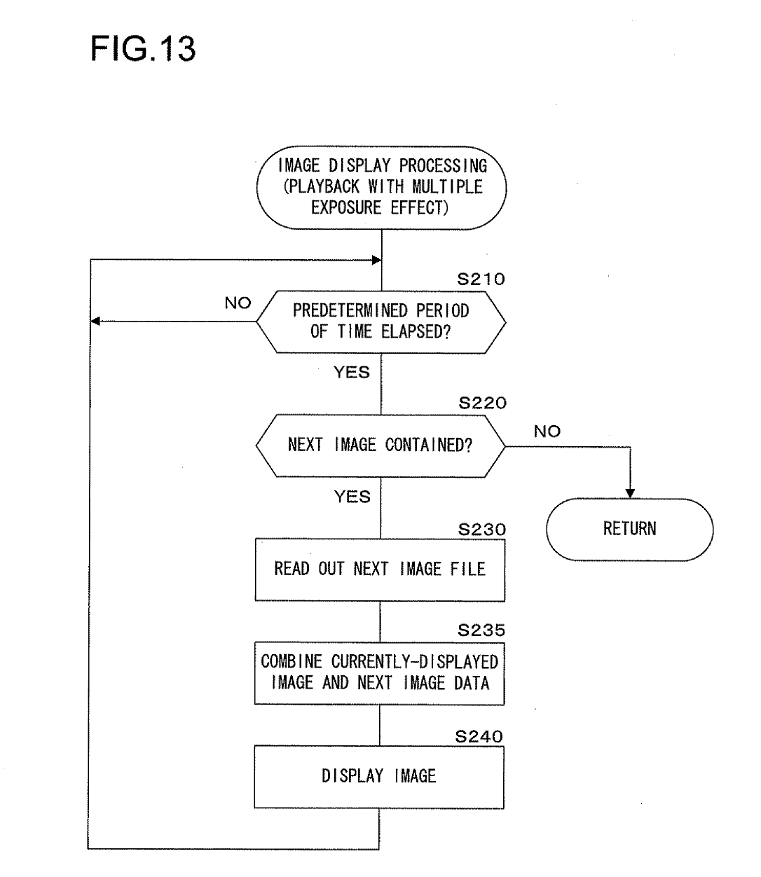

FIG. 13 is a flowchart which shows the flow of the processing executed in the “playback with multiple exposure effect” operation. It should be noted that, in FIG. 13, steps in which the same processing is performed as that in the corresponding steps shown in FIG. 12 are denoted by the same step numbers. Description will be made below mainly regarding the points of difference from what is shown in FIG. 12. In Step S235, the CPU 106 combines the image data of the current image that is currently displayed and the image data read out in Step S230. Subsequently, the flow proceeds to Step S240 in which the CPU 106 outputs the image data thus combined to the image display unit 110, thereby displaying the image data on the image display unit 110. Subsequently, the flow returns to Step S210.

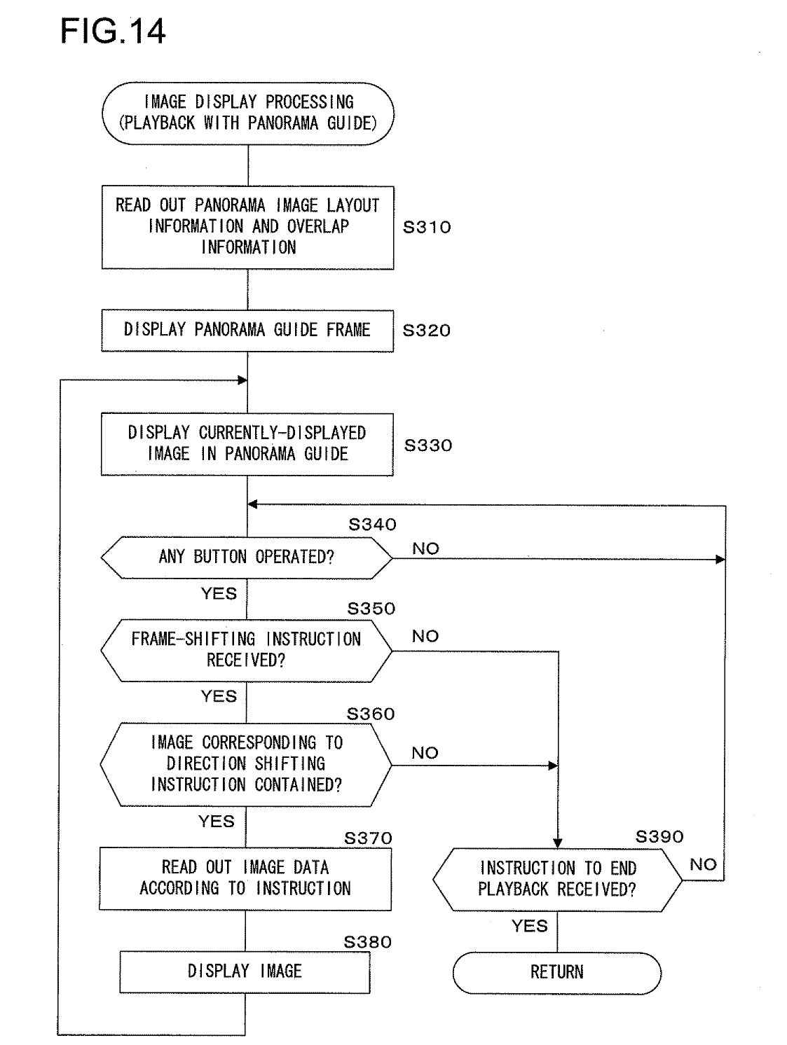

FIG. 14 is a flowchart which shows the flow of the processing executed in the “playback with panorama guide” operation. In Step S310, the CPU 106 reads out, from the MPF file of the playback target, the panorama image layout information and the overlap information that are required to generate a panorama image based upon the multiple image data contained in the MPF file.

The panorama image layout information is the information on the basis of which the multiple image data contained in the MPF file are to be laid out so as to generate a panorama image. Specifically, the panorama image layout information includes the matrix size of a matrix in which the multiple images are laid out, the layout position of the first individual image, and the layout rule according to which the subsequent images are laid out on the basis of the layout position of the first individual image. It should be noted that examples of the layout rule include “unidirectional”, “clockwise”, “counterclockwise”, “zigzag”, and so forth. Moreover, the overlap information is the information which indicates a region where adjacent images overlap, which is used in the panorama image generating operation. The overlap information includes horizontal overlap information which indicates the overlap range in the horizontal direction and vertical overlap information which indicates the overlap range in the vertical direction.

Subsequently, the flow proceeds to Step S320 in which the CPU 106 displays a panorama guide frame superimposed on the currently-displayed image based upon the panorama image layout information and the overlap information read out in Step S310. For example, the panorama guide frame is displayed superimposed on the lower-right position of the currently-displayed image as with the panorama guide frame 6a shown in FIG. 6. Subsequently, the flow proceeds to Step S330 in which the CPU 106 displays the frame 6b that corresponds to the layout position of the currently-displayed image in a manner that differs from the frames which indicate the other respective images, as shown in FIG. 6, thereby marking the layout position of the current-displayed image in the panorama image. Subsequently, the flow proceeds to Step S340.

In Step S340, the CPU 106 judges whether or not the user operates any of the buttons included in the operation member 107. When the judgment is “true” in Step S340, the flow proceeds to Step S350. In Step S350, the CPU 106 judges whether or not the operation by the user matches the operation which is an instruction to shift the currently-display image indication frame from the frame 6b that corresponds to the currently-displayed image to any one of the other frames in the panorama guide frame 6a. When the judgment is “false” in Step S350, the flow proceeds to Step S390 described later. Conversely, when the judgment is “true” in Step S350, the flow proceeds to Step S360.

In Step S360, the CPU 106 judges whether or not there is an image that corresponds to a frame-shifting instruction given by the user. When the judgment is “false” in Step S360, the flow proceeds to Step S390. In Step S390, the CPU 106 judges whether or not the CPU 106 receives an instruction to end the “playback with panorama guide” operation by the user operating the operation member 107. When the judgment is “false” in Step S390, the flow returns to Step S340. Conversely, when the judgment is “true” in Step S390, the flow returns to the operation shown in FIG. 10.

On the other hand, when the judgment is “true” in Step S360, the flow proceeds to Step S370. In Step S370, the CPU 106 reads out the image newly selected in the frame-shifting operation, i.e., the image data of the image that corresponds to the frame position of the currently-displayed image indication frame in the panorama image after it is shifted. Subsequently, the flow proceeds to Step S380. In Step S380, the CPU 106 outputs the image data thus read out in Step S370 to the display unit 110, thereby displaying the image. In this stage, the panorama guide frame 6a is displayed on the updated image on the display screen of the display unit 110. Furthermore, of the frames in the panorama guide frame 6a, the frame that corresponds to the updated currently-displayed image is displayed in a manner that differs from the other frames. Subsequently, the flow returns to Step S330.

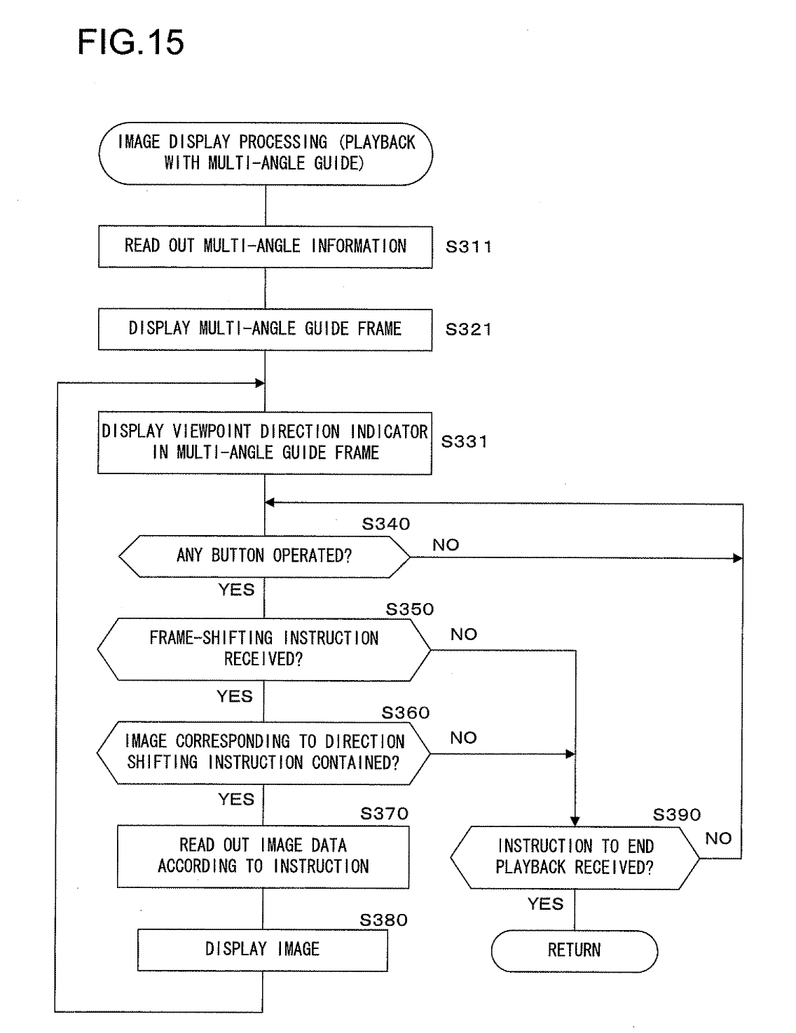

FIG. 15 is a flowchart which shows the flow of the processing executed in the “playback with multi-angle guide” operation. It should be noted that, in FIG. 15, steps in which the same processing is performed as that in the corresponding steps shown in FIG. 14 are denoted by the same step numbers. Description will be made below mainly regarding the points of difference from what is shown in FIG. 14. In Step S311, the CPU 106 reads out, from the MPF file of the playback target, multi-angle information required to generate a multi-angle image based upon the multiple image data contained in the MPF file.

The multi-angle information is information which specifies the image data layout according to how multiple image data contained in an MPF file are laid out so as to generate a multi-angle image. The multi-angle information includes information which specifies the position relation between the respective images contained in the MPF file and information which specifies the inclination angles of each image in the space. The information which specifies the position relation between the respective images contained in the MPF file includes: the distance between the respective images in the horizontal axis (X axis) direction; the distance between the respective images in the vertical axis (Y axis) direction; and the distance between the respective images in the collimation axis (Z axis) direction. On the other hand, the information which specifies the inclination angles of each image in the space includes the pitch angle, yaw angle, and roll angle.

Subsequently, the flow proceeds to Step S321 in which the CPU 106 displays a multi-angle guide frame superimposed on the currently-displayed image based upon the multi-angle information read out in Step S311. For example, the multi-angle guide frame is displayed superimposed on the lower-right position of the currently-displayed image, as with the multi-angle guide frame 7a shown in FIG. 7. Subsequently, the flow proceeds to Step S331 in which the CPU 106 displays the information which indicates the direction along which the currently-displayed image is viewed, e.g., an arrow which indicates the direction of the point of view. Subsequently, the flow proceeds to Step S340.

The present embodiment described above provides the following functions and effects.

(1) The CPU 106 is configured to read out the MP type and the extended MP type from the header part of an MPF file so as to judge the type of the MPF file, to select a display operation from among multiple display operations according to the type, to execute the display operation thus selected for the MPF file, and to display the image thus processed on the display unit 110. Thus, such an arrangement allows the CPU 106 to select a suitable display operation that corresponds to the type of the MPF file, thereby providing a suitable playback operation.

(2) When multiple playback methods are determined by the CPU 106, as shown in FIG. 11B, the CPU 106 is configured to display the multiple playback methods on a selection screen for the user, and to select a desired playback method according to an instruction from the user. Thus, when there are multiple playback method candidates, such an arrangement allows the user to select a desired playback method.

(3) In the judgment operation in which the CPU 106 judges at least one or more selectable playback method candidates based upon the type and the image acquisition conditions, the CPU 106 selects the possible playback methods for the MPF file from among only the playback methods that have been enabled via the MPF file playback method setting menu shown in FIG. 8. Thus, such an arrangement is capable of selecting only the playback methods that match the user's intentions based upon the setting content set beforehand by the user.

(4) Such an arrangement allows the CPU 106 to select the playback methods also giving consideration to the image acquisition information with respect to an MPF file. Thus, such an arrangement is capable of playing back an image with an optimum playback method also giving consideration to the image acquisition information.

(5) Such an arrangement allows the user to select the “playback method with effects” from among “continuous playback”, “multiple exposure effect playback”, “playback with panorama guide”, and “playback with multi-angle guide”. Thus, such an arrangement allows the optimum playback method that corresponds to the type of the MPF file and the image acquisition information to be selected from among the aforementioned four playback methods.

[Modification] It should be noted that the camera according to the embodiment described above may be modified as follows.

(1) With the above-described embodiment, as shown in FIG. 9, when the type of the MPF file is “continuous shooting” and the image acquisition condition is “without acceleration”, such an arrangement selects the two playback methods “continuous playback” and “playback with multiple exposure effect” as the playback method candidates. When the type of the MPF file is “fixed-point image acquisition”, such an arrangement selects the two playback methods “continuous playback” and “playback with multiple exposure”. When the type of the MPF file is “panorama” and the image acquisition condition is “single row”, such an arrangement selects the two playback methods “continuous playback” and “playback with panorama guide” as the playback method candidates. However, an arrangement may be configured to select only one playback method as the playback method candidate. With such an arrangement, in all cases, only one playback method is selected based upon a given combination of the type and the image acquisition conditions. Thus, such an arrangement does not require the steps indicated by Steps S140 through S160 shown in FIG. 10, thereby simplifying the operation.

(2) With the above-described embodiment, when the judgment is “false” in Step S140 in FIG. 10, i.e., when there are multiple selectable playback methods, the selection screen shown in FIG. 11B is displayed, which allows the user to select a desired playback method. Also, when there are multiple selectable playback methods, such an arrangement may display buttons superimposed on an image such that they allow the user to select one from among the multiple playback method candidates. With such an arrangement, the CPU 106 may be preferably configured to perform the “playback with effects” operation according to the button pressed by the user.

(3) Description has been made in the embodiment regarding an example in which the CPU 106 is configured to select the image playback methods based upon an type of the MPF file, i.e., the MP type, extended MP type, and image acquisition conditions. Also, the CPU 106 may select the image playback methods based upon only the type of the MPF file.

Description has been made in the embodiment regarding an arrangement configured to allow the user to switch the state of each playback method supported by the camera 100 between the enabled state and the disabled state via the MPF file playback method setting menu shown in FIG. 8. Also, an arrangement may be configured to maintain all the playback methods supported by the camera 100 in the enabled state, i.e., such that the user cannot override each playback method.

(5) Description has been made in the embodiment regarding an example in which the present invention is applied to the camera 100. Also, the present invention is applicable to other devices having a function of reading out an image file so as to play back the image file thus read out, such as personal computers, cellular phone terminals, and so forth. Also, a terminal such as a personal computer or the like storing image files may be connected via a communication line to a server apparatus storing a program configured to execute the operations shown in FIG. 10 and FIGS. 12 through 15. With such an arrangement, the server apparatus may be configured to execute the operations shown in FIG. 10 and FIGS. 12 through 15 for an image file received from the terminal side, and to transmit the resulting image thus played back to the terminal side so as to display the transmitted image on the terminal side.

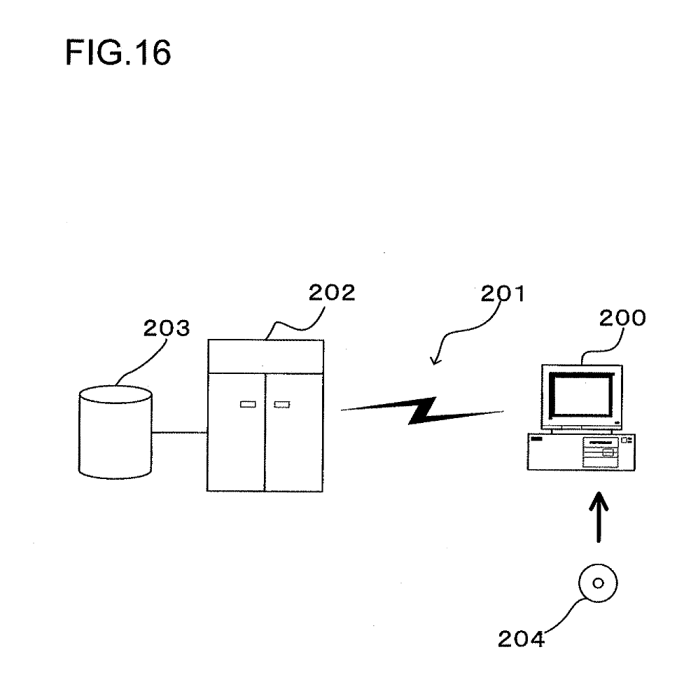

In a case in which the operations shown in FIG. 10 and FIGS. 12 through 15 are executed by a personal computer or the like, the program may be provided via a recording medium such as a CD-ROM, USB memory (“flash memory”), memory card, or the like, or otherwise via a data signal such as the Internet. FIG. 16 shows such an arrangement. A personal computer 200 is configured to receive a program via a CD-ROM 204. Furthermore, the personal computer 200 has a function of connecting with a communication line 201. The computer 202 functions as a server computer configured to provide the aforementioned program, and to store the program in a recording medium such as a hard disk 203 or the like. The communication line 201 is configured as a communication line such as the Internet or otherwise as a dedicated communication line. The computer 202 is configured to read out a program using the hard disk 203, and to transmit the program thus read out to the personal computer 200 via the communication line 201. That is to say, such an arrangement transmits a program as a data signal via a carrier wave on the communication line 201. As described above, such a program can be supplied as a computer program product in various kinds of forms such as a recording medium, data signal (carrier wave), etc.

It should be noted that the present invention is by no means intended to be limited by the aforementioned embodiment, as long as such a modification would not damage featured functions of the present invention. Also, an arrangement may be made by combining the aforementioned embodiment and multiple modifications.

The entire contents disclosed in Japanese Patent Application No. 2010-053021 (filed on Mar. 10, 2010) are incorporated herein by reference.

1. A display control apparatus comprising:
a judgment unit configured to judge a type of a multi-image file that contains a plurality of sets of image data and has a predetermined common extension, by reading out type information from the multi-image file;
a selecting unit configured to select, from among a plurality of display operations, a display operation that corresponds to the type judged by the judgment unit; and
an executing unit configured to execute, for the multi-image file, the display operation selected by the selecting unit, and to display an image on a display apparatus.

2. A display control apparatus according to claim 1, wherein:
when there is a plurality of possible display operations that correspond to the type, the selecting unit is configured to present the plurality of display operations to the user, and to select a single display operation according to an instruction from the user.

3. A display control apparatus according to claim 2, wherein:
in the presentation of the plurality of display operations, the selecting unit is configured to present only display operations selected beforehand by the user.

4. A display control apparatus according to claim 1, wherein:
the selecting unit is configured to select the display operation also giving consideration to image acquisition information with respect to the multi-image file.

5. A display control apparatus according to claim 1, wherein:
the display operations include at least one from among: (1) a continuous playback operation in which image data to be displayed is switched among the plurality of sets of image data contained in the multi-image file, and a set of image data thus switched is displayed; (2) a combining playback operation in which the plurality of sets of image data contained in the multi-image file are combined, and a set of image data thus combined is displayed; and (3) a playback-with-guide operation in which, in a case in which the plurality of sets of image data contained in the multi-image file are laid out so as to generate a single laid-out image, a given single image is displayed from among the plurality of sets of image data contained in the multi-image file while information is displayed which indicates a laid-out position of the currently-displayed image in the laid-out image.

6. A computer program product comprising a display control program configured to instruct a computer to execute:
a judgment step of judging a type of a multi-image file which contains a plurality of sets of image data and has a predetermined common extension, by reading out type information from the multi-image file;
a selecting step of selecting, from among a plurality of display operations, a display operation that corresponds to the type judged in the judgment step; and
an execution step of executing, for the multi-image file, the display operation selected in the selecting step, and of displaying an image on a display apparatus.

7. A display control system comprising:
a display control apparatus; and
a display apparatus, wherein:
the display control apparatus comprises:
a judgment unit configured to judge a type of a multi-image file which contains a plurality of image data and has a predetermined common extension, by reading out type information from the multi-image file;
a selecting unit configured to select, from among a plurality of display operations, a display operation that corresponds to the type judged by the judgment unit; and
an executing unit configured to execute, for the multi-image files, the display operation selected by the selecting unit, and to display an image on a display apparatus.
and wherein the display apparatus comprises a display unit configured to display an image according to the display control signal received from the display control apparatus.

8. A display control method executed by a computer, comprising:
a judgment step of judging a type of a multi-image file which contains a plurality of sets of image data and has a predetermined common extension, by reading out type information from the multi-image file;
a selecting step of selecting, from among a plurality of display operations, a display operation that corresponds to the type judged in the judgment step; and
an execution step of executing, for the multi-image file, the display operation selected in the selecting step, and of displaying an image on a display apparatus.

9. A display control apparatus according to claim 2, wherein:
the selecting unit is configured to select the display operation also giving consideration to image acquisition information with respect to the multi-image file.

10. A display control apparatus according to claim 3, wherein:
the selecting unit is configured to select the display operation also giving consideration to image acquisition information with respect to the multi-image file.

11. A display control apparatus according to claim 2, wherein:
the display operations include at least one from among: (1) a continuous playback operation in which image data to be displayed is switched among the plurality of sets of image data contained in the multi-image file, and a set of image data thus switched is displayed; (2) a combining playback operation in which the plurality of sets of image data contained in the multi-image file are combined, and a set of image data thus combined is displayed; and (3) a playback-with-guide operation in which, in a case in which the plurality of sets of image data contained in the multi-image file are laid out so as to generate a single laid-out image, a given single image is displayed from among the plurality of sets of image data contained in the multi-image file while information is displayed which indicates a laid-out position of the currently-displayed image in the laid-out image.

12. A display control apparatus according to claim 3, wherein:
the display operations include at least one from among: (1) a continuous playback operation in which image data to be displayed is switched among the plurality of sets of image data contained in the multi-image file, and a set of image data thus switched is displayed; (2) a combining playback operation in which the plurality of sets of image data contained in the multi-image file are combined, and a set of image data thus combined is displayed; and (3) a playback-with-guide operation in which, in a case in which the plurality of sets of image data contained in the multi-image file are laid out so as to generate a single laid-out image, a given single image is displayed from among the plurality of sets of image data contained in the multi-image file while information is displayed which indicates a laid-out position of the currently-displayed image in the laid-out image.

13. A display control apparatus according to claim 4, wherein:
the display operations include at least one from among: (1) a continuous playback operation in which image data to be displayed is switched among the plurality of sets of image data contained in the multi-image file, and a set of image data thus switched is displayed; (2) a combining playback operation in which the plurality of sets of image data contained in the multi-image file are combined, and a set of image data thus combined is displayed; and (3) a playback-with-guide operation in which, in a case in which the plurality of sets of image data contained in the multi-image file are laid out so as to generate a single laid-out image, a given single image is displayed from among the plurality of sets of image data contained in the multi-image file while information is displayed which indicates a laid-out position of the currently-displayed image in the laid-out image.

14. A display control apparatus according to claim 9, wherein:
the display operations include at least one from among: (1) a continuous playback operation in which image data to be displayed is switched among the plurality of sets of image data contained in the multi-image file, and a set of image data thus switched is displayed; (2) a combining playback operation in which the plurality of sets of image data contained in the multi-image file are combined, and a set of image data thus combined is displayed; and (3) a playback-with-guide operation in which, in a case in which the plurality of sets of image data contained in the multi-image file are laid out so as to generate a single laid-out image, a given single image is displayed from among the plurality of sets of image data contained in the multi-image file while information is displayed which indicates a laid-out position of the currently-displayed image in the laid-out image.

15. A display control apparatus according to claim 10, wherein:
the display operations include at least one from among: (1) a continuous playback operation in which image data to be displayed is switched among the plurality of sets of image data contained in the multi-image file, and a set of image data thus switched is displayed; (2) a combining playback operation in which the plurality of sets of image data contained in the multi-image file are combined, and a set of image data thus combined is displayed; and (3) a playback-with-guide operation in which, in a case in which the plurality of sets of image data contained in the multi-image file are laid out so as to generate a single laid-out image, a given single image is displayed from among the plurality of sets of image data contained in the multi-image file while information is displayed which indicates a laid-out position of the currently-displayed image in the laid-out image.
